(19) United States
(12) Patent Application Publication
(10) Pub. No.: US 2017/0106926 A1
(43) Pub. Date: Apr. 20, 2017

(54) MODULAR EXTENSION TUBE

(71) Applicant: J.G.B.D. Consult Sprl, Lummen (BE)

(72) Inventor: Hans-Joerg HABERNEGG, Kaufbeuren (DE)

(73) Assignee: J.G.B.D. Consult Sprl, Lummen (BE)

(21) Appl. No.: 15/128,546

(22) PCT Filed: Mar. 26, 2015
(86) PCT No.: PCT/EP2015/056499

§ 371 Date: Sep. 23, 2016

(30) Foreign Application Priority Data
Apr. 2, 2014 (EP) 14163234.9

(51) Int. Cl. B62D 63/06; B62D 21/20; B62D 21/14

(52) U.S. Cl. CPC B62D 63/061; B62D 21/14; B62D 21/20

(57) ABSTRACT

With an apparatus for changing the length of the loading surface of vehicles, particularly trailers and semi-trailers, wherein a vehicle can be equipped with a central support configured as a tube or trough and an inner support that can be pushed into and pulled out of the former, the known disadvantages are supposed to be avoided, particularly a solution is supposed to be made available for the fact that the trailing chassis does not have to have any comprehensive preparation for later extensibility. This is achieved in that attachment elements for a ring beam are provided on the vehicle, wherein the inner support is provided with a ring beam that is open on the top side or a ring beam that is closed all around and has an upper brace.

In order to be able to adapt the length of the loading surface of trailers and semi-trailers to the cargo, what are called extensible vehicles are known. In these vehicles, a central support is configured as a tube or as an open trough, into which a second tube or a second support can be pushed and then locked in place on it. The bending moments that occur when the vehicle is loaded are transferred from an upper brace of the inner tube to an upper brace of the outer tube. For this purpose, the upper brace of the outer tube is structured to be reinforced, if necessary. The longitudinal forces that occur during travel operation, particularly the tensile force, the acceleration forces and the braking forces, are absorbed by a locking mechanism that connects the inner tube and the outer tube with one another with shape fit. For this purpose, both the inner tube and the outer tube possess corresponding latching apparatuses.

In order to ensure the energy supply, particularly also the necessary electrical devices, from the towing vehicle or a leading chassis to the trailer or to a trailing chassis, supply lines are provided on or in the inner tube, which lines are connected with a leading chassis or a gooseneck at the front, in the direction of travel. At the rear, in the direction of travel, the lines in the inner tube are firmly connected with the trailing chassis.

It is a disadvantage of the known configuration that it must be decided, already when purchasing a vehicle, whether or not an extensible loading surface is required at all. If yes, the trailing chassis must be structured with a corresponding design, and must have a reinforced upper brace, a locking mechanism between inner tube and outer tube, and line connections in the chassis, for example. This is connected with not insignificant costs and also corresponding material and weight.

It is therefore the task of the invention to avoid the disadvantages present in the state of the art, particularly to make available a solution so that the trailing chassis does not have to have any comprehensive preparation for later extensibility.

According to the invention, this task is accomplished in that in the case of a vehicle can be equipped with a central support formed by a tube or trough, and an extensible inner support that can be pushed into and pulled out of the former, and attachment elements for a ring beam are provided on the vehicle for this purpose, wherein the inner support is provided with a ring beam that is open on the top side or with a ring beam that is closed all around, having an upper brace. In this manner, an inner support that can be pushed in and pulled out can be retrofitted in simple manner. For this purpose, the ring beam on the inner support is simply connected to the vehicle with the attachment means. Therefore the vehicle can be easily equipped with an inner support that can be pushed in and pulled out. In this way, the result is achieved that the “change the length of the loading surface” function can be added at any desired point in time, even later, to a vehicle that is already fully capable of functioning, particularly a trailer or semi-trailer.

No preparations for later extensibility are required on the trailing chassis having a central support configured as a trough or tube. In this way, possibly unnecessary costs can be saved.

Furthermore, trailing vehicles can be exchanged as desired. Thus, an inner support of the vehicle, which support can be pushed in and pulled out, can be easily removed from the vehicle by means of the releasable connection between ring beam and vehicle, and attached to a different replacement vehicle.

The proposed ring beam makes it possible to transfer the vertical bending moments that occur during operation from the inner support to the chassis, particularly to the trailing chassis, without the upper brace of the outer tube having to be reinforced. It is even possible to use a central support configured as a trough, in other words open at the top. Depending on the embodiment of the ring beam, either the upper brace of the ring beam or a locking mechanism affixed in vertical crosspieces absorb the bending forces of the inner support and pass these directly into coupling tabs of the central support in the vehicle, particularly the trailing chassis, by way of its vertical crosspieces.

For this purpose, the ring beam has coupling tabs on its underside, as attachment elements, which tabs can be fixed in place with coupling tabs on the chassis, by way of bolts.

According to the invention, the ring beam is provided with a locking mechanism for a shape-fit connection with the inner support. This makes it possible to connect the ring beam with the inner support in shape-fit manner, and to thereby transfer the tensile forces, braking forces, and acceleration forces that occur from the inner support to the central support and the trailing chassis. It is provided that when the ring beam is closed, the upper brace of the ring beam is configured for absorbing bending forces of the inner support.

In the case of a ring beam that is open on the top side, shape-fit elements are affixed laterally on the inner support and, opposite to it, on the ring beam, for introduction of the bending forces, which elements allow conducting the bending forces away from the crosspiece of the inner support to the vertical sides of the ring beam. In the case of the open ring beam, no upper brace is therefore required to conduct the bending forces away.

In addition, the invention also provides that the ring beam has coupling elements on its outside, for coupling supply lines to the chassis, in other words particularly the trailing chassis. As a result, supply lines of the leading chassis or a gooseneck, but also the supply lines situated in the ring beam, can be coupled with the coupled chassis, particularly the trailing chassis.

Furthermore, it is provided that the inner support has a flexible line guide for conveying supply lines from a leading chassis or a gooseneck to the ring beam. In this way, flexible line guidance is made possible, and the supply lines are conveyed from the leading gooseneck or chassis to the ring beam that is displaceable on the inner support, in simple manner.

Finally, it is provided that the ring beam is displaceable on the inner support and can be latched in place in the desired position. In this way, the length of the loading surface can be varied and optimally adapted to the respective cargo or other requirements.

In the following, the invention will be explained using the drawing. Articles or elements that correspond to one another are provided with the same reference symbols in all the figures. The drawing shows, in

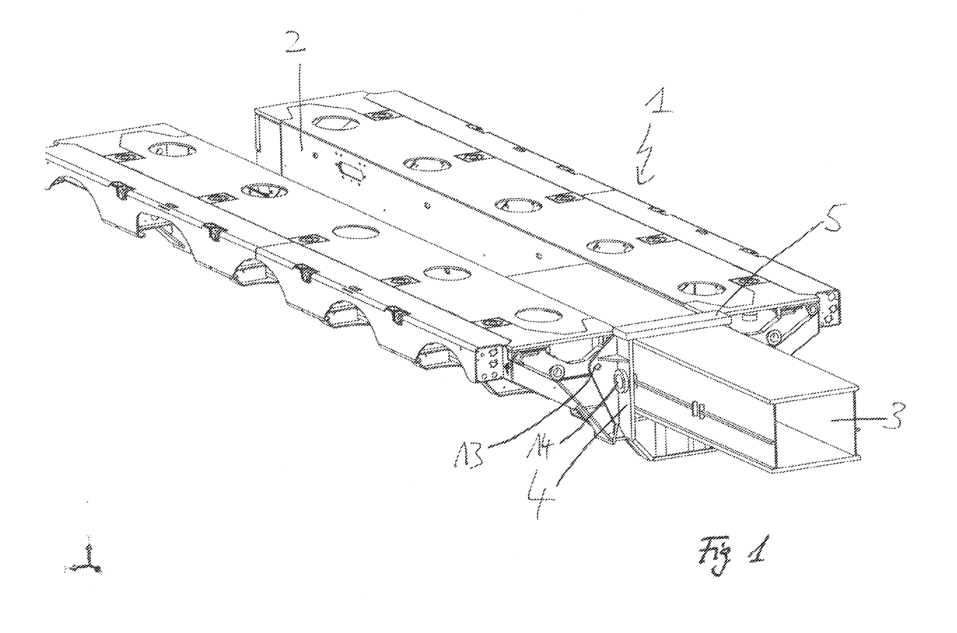

FIG. 1 a perspective front view of a vehicle according to the invention, having a central support configured as a trough, and a partly pulled-out inner support having a closed ring beam with upper brace,

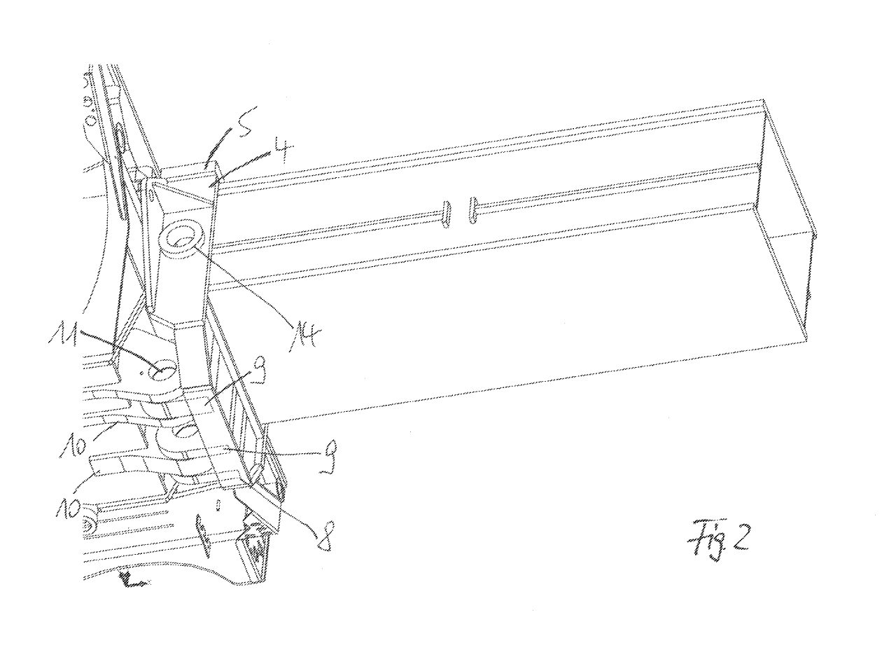

FIG. 2 a detail view according to FIG. 1,

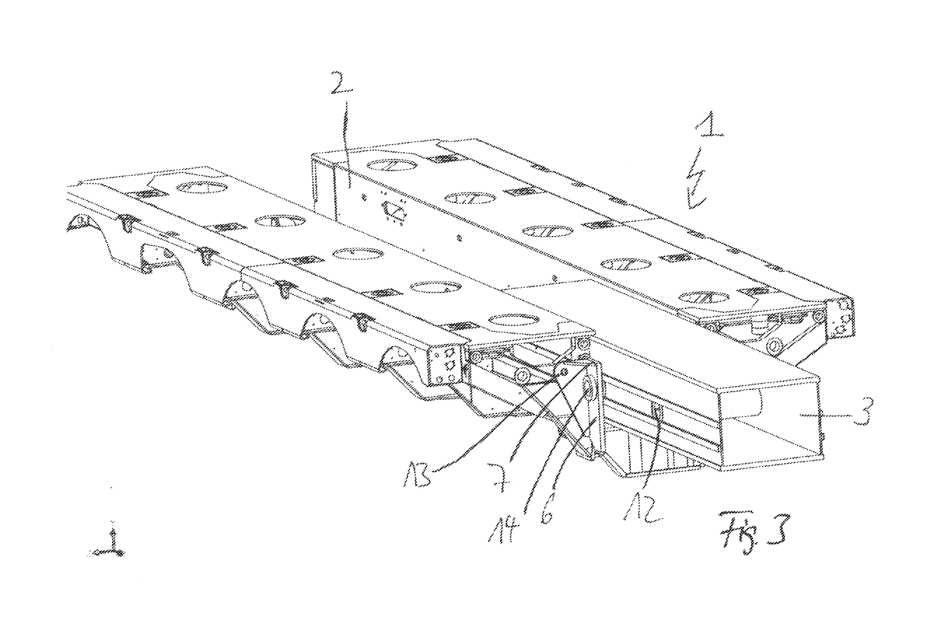

FIG. 3 a perspective front view with a ring beam open at the top, and in

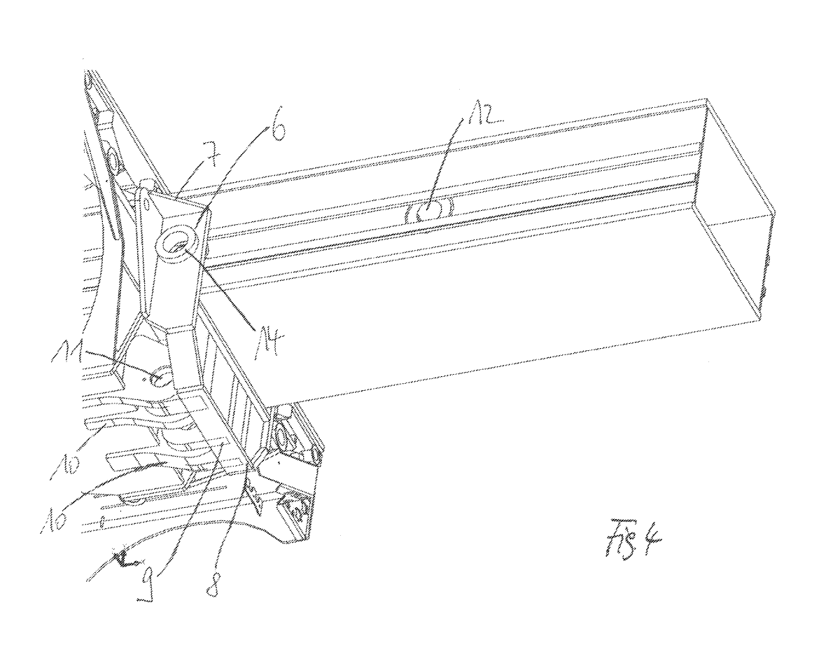

FIG. 4 a detail view according to FIG. 3.

A chassis of a vehicle not shown in any detail in its totality, particularly a trailer or semi-trailer, the chassis indicated in general with 1, has a central support 2 configured as a trough 2 and an inner support 3 that can be pushed into and pulled out of the former, in the embodiment shown. FIGS. 1 and 2 show a perspective view of a vehicle 1 according to the invention, having a central support 2 configured as a trough 2 and a partly pulled-out inner support 3, with a ring beam 4 that is closed all around and has an upper brace 5.

In FIGS. 3 and 4, a perspective view of a vehicle 1 according to the invention is shown, having a central support 2 configured as a trough 2 and a partly pulled-out inner support 3 having a ring beam 6 that is open on the top side 7, at the top.

In each case, the ring beam 4, 6 has coupling tabs 9 on its underside 8, as attachment elements, which can be fixed in place with corresponding coupling tabs 10 on the vehicle 1, by way of bolts not shown in any detail, which can be inserted through the holes 11 of the coupling tabs 10. Furthermore, the ring beam 4, 6 is provided with at least one locking apparatus 14 for a shape-fit connection with the inner support 3, which has a counter-locking piece 12 for this purpose. When the ring beam 4 is closed, the upper brace 5 of the ring beam 4 is configured for absorbing bending forces of the inner support 3.

In the case of the ring beam 6 that is open on the top side 7, locking elements 12 are disposed laterally on the inner support 3 for the introduction of bending forces, and locking elements 14 are disposed on the opposite sides of the ring beam 6, in each instance. Furthermore, the ring beam 4, 6 has coupling elements 13 on its outside, for coupling supply lines with the vehicle 1.

Beyond this, the inner support 3 possesses a flexible line guide for conveying supply lines from a leading chassis or a gooseneck to the ring beam 4, 6. The ring beam 4, 6 is displaceable on the inner support 3 and can be latched in place in the desired position.

The invention can be summarized as follows: It relates to a change in the length of the loading surface of trailers and semi-trailers.

In order to allow retrofitting, in the case of a vehicle 1 having a central support 2 configured as a tube or trough 2 and an inner support 3 that can be pushed into and pulled out of the former, the inner support 3 is provided with a ring beam 4 that is open on the top side 7 or with a ring beam 4 that is closed all around and has an upper brace 5, wherein at the same time, attachment elements 10 for the ring beam 4 are provided on the vehicle 1. This makes it possible to transfer the bending forces that occur during operation from the inner support 3 to the central support 2. For this purpose, the ring beam 4 has coupling tabs 9 on its underside 8, as attachment elements, which can be fixed in place with coupling tabs 10 on the chassis, by way of bolts. Furthermore, the ring beam 4, 6 is provided with a locking apparatus 14 for a shape-fit connection with the inner support 3, which has a counter-locking piece 12 for this purpose, so that the tensile forces, braking forces, and acceleration forces that occur can also be transferred from the inner support 3 to the central support 2.

Of course, the invention is not restricted to the exemplary embodiments shown. Further embodiments are possible without departing from the basic idea.

### REFERENCE SYMBOL LIST

1 vehicle

2 central support, trough

3 inner support

4 closed ring beam

5 upper brace

6 open ring beam

7 top side of ring beam

8 underside of ring beam

9 coupling tabs

10 coupling tabs

11 holes of the coupling tabs

12 locking element, counter-locking piece

13 coupling element for supply line

14 locking element, locking apparatus

1. Apparatus for changing the length of the loading surface of vehicles, particularly trailers and semi-trailers, wherein a vehicle (1) can be equipped with a central support (2) configured as a tube or trough (2) and an inner support (3) that can be pushed into and pulled out of the former,
wherein
attachment elements (10) for a ring beam (4, 6) are provided on the vehicle (1), wherein the inner support (3) is provided with a ring beam (6) that is open on the top side (7) or a ring beam (4) that is closed all around and has an upper brace (5).

2. Apparatus according to claim 1,
wherein
the ring beam (4, 6) has coupling tabs (9) on its underside (8) as attachment elements, which can be fixed in place with coupling tabs (10) on the vehicle (1), by way of bolts.

3. Apparatus according to claim 1
wherein
the ring beam (4, 6) is provided with at least one locking apparatus (14) for a shape-fit connection with the inner support (3).

4. Apparatus according to claim 1,
wherein
in the case of a closed ring beam (4), the upper brace (5) of the ring beam (4) is configured to absorb bending forces of the inner support (3).

5. Apparatus according to claim 1,
wherein
in the case of a ring beam (6) that is open on the top side (7), locking elements (12, 14) are laterally disposed on the inner support (3) and on the opposite sides of the ring beam (6), for the introduction of bending forces.

6. Apparatus according to claim 1,
wherein
the ring beam (4, 6) has coupling elements (13) on its outside, for coupling supply lines with the vehicle (1).

7. Apparatus according to claim 1,
wherein
the inner support (3) has a flexible line guide for conveying supply lines from a leading chassis or a gooseneck into the ring beam (4, 6).

8. Apparatus according to claim 1,
wherein
the ring beam (4, 6) can be displaced on the inner support (3) and latched in the desired position.
